(19) United States
(12) Patent Application Publication
(10) Pub. No.: US 2006/0209037 A1
(43) Pub. Date: Sep. 21, 2006

(54) Method and system for providing haptic effects

(76) Inventors: David Wang, Ontario (CA); Mauro Rossi, Ontario (CA); Kevin Tuer, Ontario (CA); Daniel Madill, Ontario (CA)

Correspondence Address: VALENTINE A. COTTRILL, SUITE 1020 50 QUEEN STREET NORTH, KITCHENER, ON, N2H6M2, CA

(21) Appl. No.: 10/548,640

(22) PCT Filed: Mar. 15, 2004
(86) PCT No.: PCT/CA04/00383

§ 371 Date: Sep. 13, 2005

(51) Int. Cl. G09G 5/00

(52) U.S. Cl. 345/173

(57) ABSTRACT

A transparent haptic overlay device, system and method are provided. The transparent haptic overlay device (10) includes a transparent overlay (22) for transmitting the force of the user to a display (20), an actuator (24) for generating forces corresponding to haptic effects and imparting these forces to the user's finger and a controller (28) for simulating the haptic effects. The display (20) may be a touch sensitive display, which has a functionality of sensing the position of the user. Through the overlay (22), the user receives the haptic effects in response to the motion relative to the image of the objects (14) on the display (20).

### FIELD OF THE INVENTION

This invention relates to virtual effects, more specifically to a method and system for providing haptic effects associated with an image on a display.

### BACKGROUND OF THE INVENTION

In many new applications, the implementation of extra functionality to a product has resulted in applications that are more desirable to consumers (e.g. extra vehicle control functions in automobiles). In other cases, the extra functionality is a necessity resulting from the increasing complexity of the overall system (e.g. flight control systems in military aircraft). This presents a challenge for the user of the product/device, since easy access to all the functions can be distracting to the normal operation. Moreover, interfaces that are fixed and not re-configurable can limit the number of functions that are implemented and can also prevent the interface from operating in an intuitive fashion.

The addition of the sense of touch to the user interface allows the user to navigate through the options primarily based on the sense of touch, instead of relying on visual feedback only. Furthermore, the reconfigurability of the device allows the interface to be designed in an intuitive fashion. Therefore, the addition of haptic effects to a display device has clear benefits.

However, in the past, when conventional haptic devices have been integrated into display devices, they have tended to be quite expensive and they typically obstruct the view of the display.

To overcome the obstruction issue, some applications have separated the haptic device and the display (e.g. the force feedback joystick is located on a control console with the display located on the dashboard). However, this creates disconnect between what is seen and what is felt.

Other applications are limited to implementing haptic effects using only vibration devices. Specifically, in these applications, when a user passes over a particular area of the display, the user senses a vibration effect. While this provides some haptic feedback to the user, the user still needs to correlate a certain type of vibration to a specific meaning.

Some other applications use a virtual world approach as described, for example, in U.S. Pat. No. 5,986,643. In this approach, the user is required to wear a glove that has several actuators built-in and a virtual goggle heads up display. As the user reaches out to touch an object that is projected on the virtual goggle display, the actuators are enabled to apply force to individual fingers. This approach is complex and expensive.

Therefore, it is desirable to provide a new haptic device and method, which can meet that demands of scalability, reliability, reconfigurability and cost reduction.

### SUMMARY OF THE INVENTION

It is an object of the invention to provide a novel haptic device and system that obviates or mitigates at least one of the disadvantages of existing systems.

In accordance with an aspect of the present invention, there is provided a system for providing haptic effects to a user, which includes a display for providing an image of an object; and a transparent overlay haptic device. The device includes: a transparent overlay for translating the motion of the user's finger to the image and providing haptic effects to the user and a haptic effect element for generating the haptic effect on the overlay in response to the motion of the user. The user contacts the image through the overlay.

The transparent overlay haptic device may include the overlay, the actuator (active or passive), the position sensor (absolute or relative), the controller and the electrical and mechanical interfaces between the components.

In accordance with a further aspect of the present invention, there is provided a method of passively or actively applying a force in the x and y axis to a user's finger, via a transparent overlay, in such a way that does not obstruct the view of the display, to simulate haptic effects.

The transparent overlay haptic method of the present invention achieves the reconfigurability of the haptic effects generated on the device to match the display objects.

Other aspects and features of the present invention will be readily apparent to those skilled in the art from a review of the following detailed description of preferred embodiments in conjunction with the accompanying drawings.

### BRIEF DESCRIPTION OF THE DRAWINGS

The invention will be further understood from the following description with reference to the drawings in which:

FIG. 1 shows a schematic diagram of a transparent overlay haptic system including a transparent overlay haptic device and a display in accordance with an embodiment of the present invention;

FIG. 2 shows a schematic diagram of the main components of the transparent overlay haptic system of FIG. 1;

FIG. 3A shows a schematic top view of the transparent overlay haptic device in accordance with a first embodiment of the present invention;

FIG. 3B shows a schematic side view of the transparent overlay haptic device shown in FIG. 3A;

FIG. 4 shows one example of wall/edge haptic effects;

FIG. 5 shows one example of detent haptic effects;

FIG. 6A shows a schematic top view of the transparent overlay haptic device in accordance with a second embodiment of the present invention;

FIG. 6B shows a schematic side view of the transparent overlay haptic device shown in FIG. 6A;

FIG. 7A shows a schematic top view of the transparent overlay haptic device in accordance with a third embodiment of the present invention;

FIG. 7B shows a schematic side view of the transparent overlay haptic device shown in FIG. 7A;

FIG. 8A shows a schematic top view of the transparent overlay haptic device in accordance with a fourth embodiment of the present invention; and

FIG. 8B shows a cross-section view taken along the line A-A in FIG. 8A.

FIG. 9 shows a schematic diagram of the transparent overlay haptic device in accordance with a fifth embodiment of the present invention;

FIG. 10A shows a schematic top view of the transparent overlay haptic device in accordance with a sixth embodiment of the present invention;

FIG. 10B is a schematic side view of the transparent overlay haptic device shown in FIG. 10A; and

FIG. 11 shows one example of a position sensor shown in FIG. 1.

### DETAILED DESCRIPTION OF THE PREFERRED EMBODIMENTS

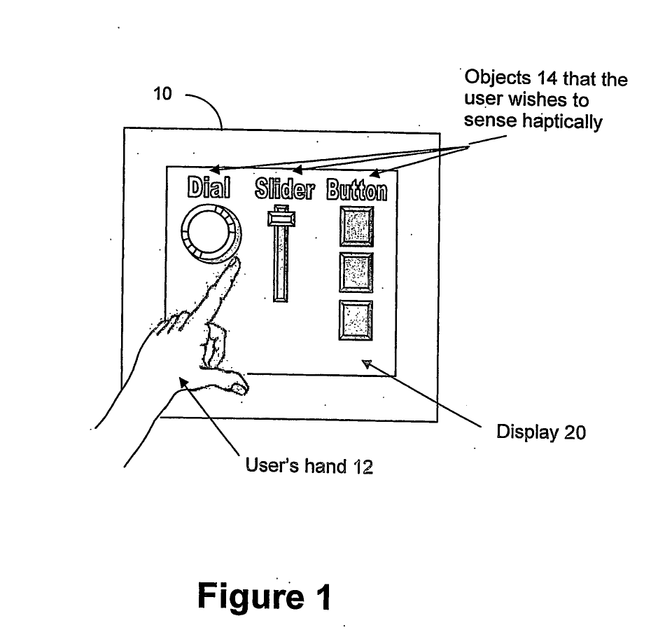

FIG. 1 illustrates the basic concept for the use of a transparent overlay haptic device 10 in accordance with an embodiment of the present invention. The transparent overlay haptic device 10 is a virtual touch/haptic device that can be used over top of a display 20. The transparent overlay haptic device 10 provides haptic effects to the user 12, corresponding to objects created on the display 20, without obstructing the view of the display.

The display 20 creates images that are used to represent different objects 14 and would be present on a user interface, e.g. dials, sliders or buttons. The user “feels” the objects by touching the transparent overlay haptic device 10 and moving his finger across the display 20. As the user's finger 12 passes over the image of an object, a haptic effect is generated to simulate the user making contact with the object.

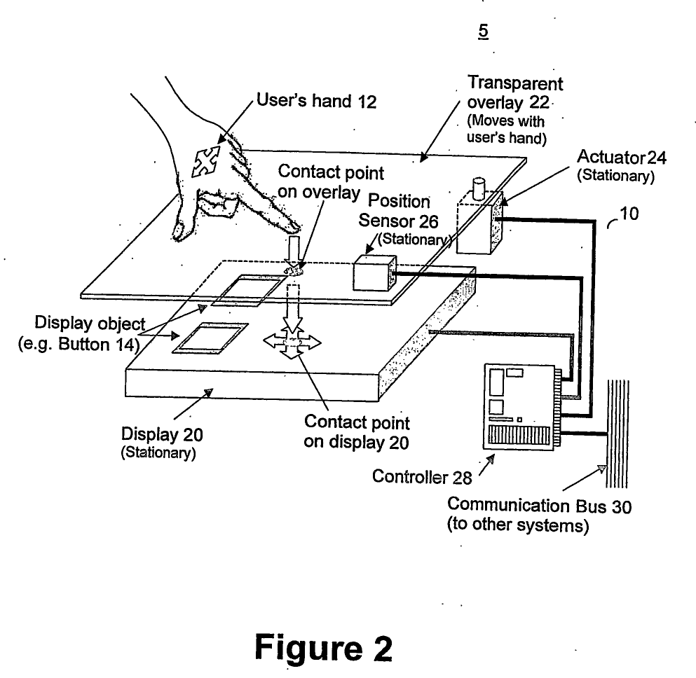

FIG. 2 illustrates the main components of a transparent overlay haptic system 5 having the device 10 and display 20 of FIG. 1, and the illustration can be used to explain how the haptic effects are implemented. The transparent overlay system 5 contains the display 20 and the transparent overlay haptic device 10 which has a transparent overlay 22, one or multiple actuators 24, a position sensor 26, a controller 28, and housing and other mechanical interfaces.

The transparent overlay 22 lies over the display 20 between the user's hand 12 and the display 20. The transparent overlay 22 is a thin, flexible film that allows the force of the user's hand 12 to be transmitted through to the display 20. When the user makes contact with the overlay 22, there is sufficient friction between the user's finger and the overlay 22, and minimal friction between the overlay 22 and the display 20, so that the overlay 22 easily moves with the user's finger. Hence the overlay 22 does not move, relative to the user's hand 12. In FIG. 2, the overlay 22 is larger than the display 20, and an actuator 24 is located in the vicinity of the overlay 22, but out of the field of view of the display 20. The actuator 24 mechanically interfaces with the overlay 22 through a mechanism to impart a force on the overlay 22. Therefore, when the actuator 24 is engaged, this force can be transmitted to the users finger, via the overlay 22, without obstructing the view of the display 20. The position of the user's finger is obtained by the position sensor 26, and is transmitted to the controller 28. The controller 28 contains the software and hardware interfaces to allow for the processing of the sensor information to control the actuators 24 to simulate the desired haptic effects, and for the communication to external subsystems via a communication bus interface 30.

The position sensor 26 records the initial position of the finger. The position sensor 26 also records the new position of the finger as the user moves the overlay 22 across the display 20. When the user touches an area on the display 20 via the overlay 22, which is to provide a force feedback, the controller 28 processes sensor signals to generate haptic effects on the overlay 22. The homing device may include helical spring, elastic, coil spring, pulleys, sliders or gas spring. The position sensor 26 may include a photo sensor or an optical sensor.

The display 20 may be a touch sensitive Liquid Crystal Display (LCD). In this case, the position of the user's finger is obtained directly from the LCD 20, and is communicated to the controller 28. As the user moves their finger, and thus the transparent overlay 22, over an object that requires a haptic effect (e.g. a line denoting the edge of a button), the controller 28 detects this collision and sends a signal to the actuator 24 that in turn applies a force to the overlay 22. The force is sensed by the user as a resistance to the desired motion.

If a “bump” type haptic effect is required to simulate the edge of a button, then the actuator 24 may be engaged for a short period of time with a large force. Many other effects can also be simulated. Once the user is within the boundary of a button object 14 on the display 20, the actuator 24 is partially engaged. Thus, additional friction is felt by the user while inside the button object 14.

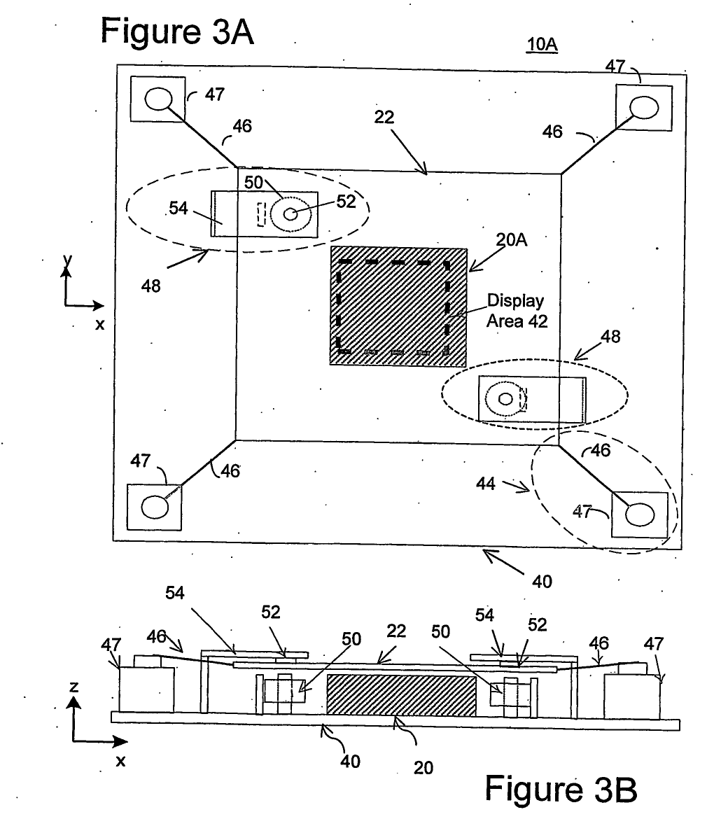

FIG. 3A shows a top view of the transparent overlay haptic device 10A in accordance with a first embodiment of the present invention. FIG. 3B shows a side view of the transparent overlay haptic device 10A of FIG. 3A.

The overlay 22 of the transparent overlay haptic device 10A is a flat rectangular clear sheet. The overlay 22 is thin enough to allow forces applied by the user's finger to pass through to the touch sensitive LCD display 20. The overlay 22 is large enough so that when starting from the home position, the user can place their finger anywhere within the display area 42 and move to any new position, without causing the edge of the overlay 22 to pass within the display area 42. The corners of the overlay 22 are attached to an overlay homing mechanism.

The transparent overlay haptic device 10A includes an overlay homing assembly 44 for the overlay 22. The homing mechanism 44 includes four springs 46 attached between the four corners of the overlay 22 and four spring mounting posts 47 grounded to the base 40 of the device 10A. They may be linear in nature, or may be part of a more complex torsional spring mechanism. When the user is not making contact with the device 10A, the springs 46 pull the overlay 22 to a home position. The spring constant for each spring is sufficient to overcome friction between the overlay 22 and any other component of the device, but is small enough not to add significant force to the user's finger when the overlay 22 is moved by the user.

The transparent overlay haptic device 10A includes an actuator assembly 48. The actuator assembly 48 includes a solenoid 50, a brake pad 52 and a brake pad bracket 54. The solenoid 50 is mounted on the base 40 of the device 10A directly below the brake pad 52, which is held in place by the brake pad bracket 54. The overlay 22 passes between the solenoid 50 and the brake pad 52. FIG. 3A shows two actuator assemblies that are positioned on the device 10A to eliminate rotation of the overlay 22 when the actuators have been activated. However, if the mechanical design of the housing prevents rotation of the overlay 22 when one actuator is activated, the second actuator assembly can be removed. When the solenoid 50 is activated, the overlay 22 is pinched between the solenoid shaft and the brake pad 52. The solenoid 50 is driven at various levels to generate various levels of force. This can be utilized to generate a variety of haptic effects.

The display 20 of the transparent overlay haptic device 10A is a touch panel LCD. The touch panel LCD 20 is used to display objects as well as provide position feedback for the user's finger.

The transparent overlay haptic device 10A includes the controller 28 as shown in FIG. 2 (not shown in FIGS. 3A-3B). The hardware within the controller 28 of the device 10A includes actuator drive circuitry, position sensing interface circuitry, a microprocessor and memory. The actuator drive circuitry takes a signal from the microprocessor and drives the actuator. The drive circuitry scheme can be any one of a number of solenoid actuation schemes. For example, a pulse width modulation scheme or a variable current source scheme could be used. The position sensing circuitry interface conditions the signal coming from the position sensor and makes it available to the microprocessor. The memory is used to store the software that is run on the microprocessor. The microprocessor loads up the software stored in memory and executes the application.

The software of the controller 28 contains the instructions needed to process the position sensor information to determine the drive signal for the actuator. The software supports simulation of a variety of effects. The software also contains instructions to generate audio feedback to the user. The software for simulating any objects on the display 20, haptic effects, and other effects feedback to the user are reprogramable.

The haptic effects are now described in detail. The transparent overlay haptic device 10A provides walls/edge effects, detent effects and damped region effects to the user. The device can also provide other haptic effects, such as a variety of types of gravity wells, friction, areas of repulsion, simulated inertia, simulated springs, simulated damping and other effects which can be created by those knowledgeable in the art.

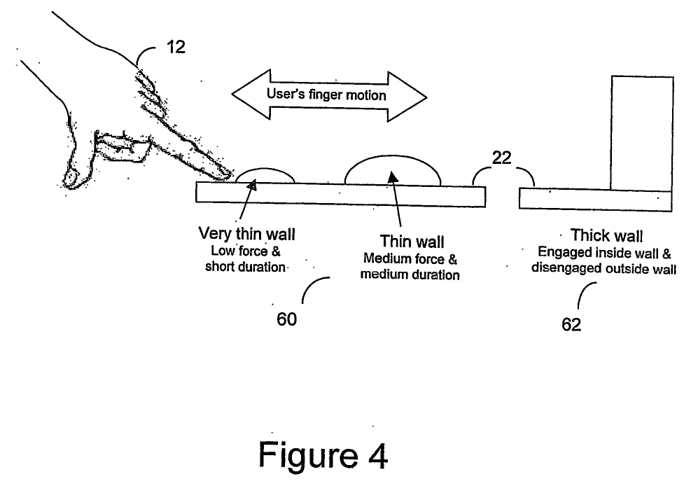

The walls/edge effects are described in detail. FIG. 4 shows the wall/edge haptic effects. As shown in FIG. 4, two types of walls can be created. A thin wall haptic effect 60 can be described as a barrier that briefly holds the overlay in a fixed position when the user collides with the object. Therefore, as the user passes through a wall, they sense a “bump”. The sensed “thickness” of the wall can be adjusted by modifying the force applied to the actuator and the amount of time that the solenoid remains enabled.

A thick wall haptic effect 62 can be described as a barrier that prevents the user from entering an area. This effect is implemented as a highly damped region (described later) where the solenoid 50 is engaged and held when the user's finger is located inside the wall. For the user to exit out of the wall, some slippage between the user's finger and the overlay 22 is required. However, the touch sensitive LCD 20 is able to detect the absolute position of the user's finger, even if there is slippage between the user's finger and the overlay 22. Once the users finger is outside the thick wall, the solenoid 50 is disengaged.

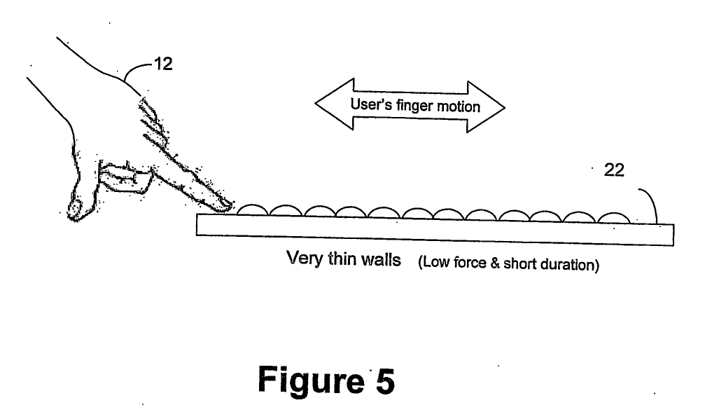

The detent effects are described in detail. FIG. 5 shows detent haptic effects. As shown in FIG. 5, detents can be implemented as a series of thin walls placed in succession. The detents can be arranged in a linear or angular configuration. As the user passes over the detent area, they pass through the thin walls, and they sense small ridges. The force for detents is typically smaller that those used for thin walls. However, the “feel” of the detents is adjustable as well by modifying the force, duration and spacing between each thin wall.

The damped region effects are now described in detail. The damped region is an area where the solenoid 50 is engaged, but only to a level that adds a certain amount of friction to the motion of the overlay 22. This resistance to motion is sensed by the user as an area where their motion is damped or restricted. The degree of restriction can be adjusted by modifying the level of force applied by the solenoid 50. Other haptic effects, which have not been discussed in detail here, can also be created with this haptic device by those knowledgeable in the art.

These haptic effects can be combined to create objects. A button may be created by using thin walls that surround a damped area. A slider may be created by using a series of detents within a damped area. A slider may be created by using damped area where the level or restriction is increased as the user slides along the damped area.

These effects and objects are only a few examples, and more complex effects and objects are provided by the transparent overlay haptic device 10A.

Combined with the touch panel LCD 20, the transparent overlay haptic device 10A has two and one half degrees of freedom; translation in the x-axis, y-axis and a selection in the z-axis. The touch pad of the LCD 20 can detect when the user presses down on the display. The device 10A affords enough haptic degrees of freedom to implement unique effects corresponding to different control devices (e.g. knobs, buttons, sliders, etc.). The haptic effects are generated in a passive manner. Only a braking action is applied to the overlay 22 in order to generate the haptic effects. This is in contrast to many more expensive haptic devices where motors are used to generate the haptic effects.

The overlay 22 is returned to a home position after the user breaks contact with the device. Without a homing mechanism, the overlay 22 may be railed to the limits of the device on subsequent user motions. In the event of a failure of the transparent overlay haptic device 10A (e.g. broken spring), the user can still interact with the application via the touch sensitive LCD 20, and only loses the haptic effects. Hence, only partial functionality is lost in the event of a failure. The software contains instructions to generate audio feedback to further assist the user in determining where the user's finger is located on the display 20.

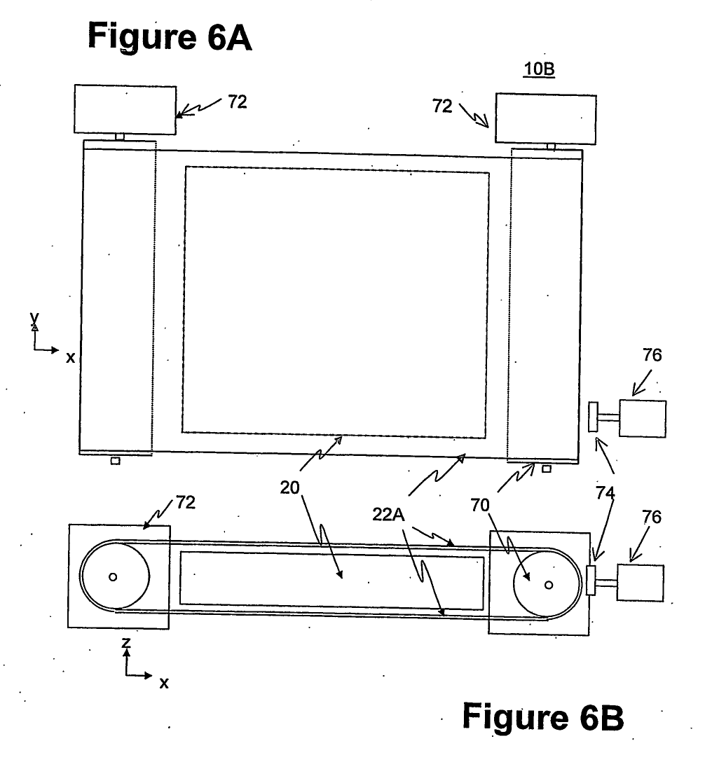

FIG. 6A shows a top view of a transparent overlay haptic device 10B in accordance with a second embodiment of the present invention. FIG. 6B shows a schematic side view of the transparent overlay haptic device 10B shown in FIG. 6A. The transparent overlay haptic device 10B includes a clear overlay 22A, a roller 70 for rotating the clear overlay 22A in x-axis, and a roller mounting 72 for the roller 70. The transparent overlay haptic 10B further includes a brake actuator 76 (such as a solenoid) and the brake pad 74 as the barking mechanism for the overlay 22A. The brake actuator 76 may be a hydraulic cylinder, pneumatic cylinder.

The transparent overlay haptic device 10A shown in FIGS. 3A-3B has two and a half degree of freedom (two degrees of freedom for the x and y axis plus 0.5 degrees of freedom for the z-axis). The transparent overlay haptic device 10B shown in FIGS. 6A-6B reduces the number of degrees of freedom to one and a half (one dgree of freedom for the x axis plus 0.5 degrees of freedom for the z-axis), which allows for the considerable reduction in size of the invention. The reduction in size is accomplished by eliminating haptic effects in the y-axis and by converting the overlay sheet 22A to an overlay roll. The transparent overlay haptic device 10B only needs to be slightly bigger than the display 20.

The transparent overlay haptic device 10B also allows for the easy incorporation of motors into the design. This allows for the generation of more complex haptic effects since the actuation becomes active. The difference between a passive device and an active device is that the passive device relies on the user to generate effects, while the active device can generate the effects independently of the user. For example, if the user holds their finger in a fixed location, the passive device cannot generate any force on the user's finger while the active device can.

There is also no need for a homing mechanism (either a passive spring mechanism or active motor drive mechanism) in the transparent overlay haptic device 10B since the overlay 22A only moves in one axis and the continuous roll of overlay material is fed back over the display area as the user moves their finger.

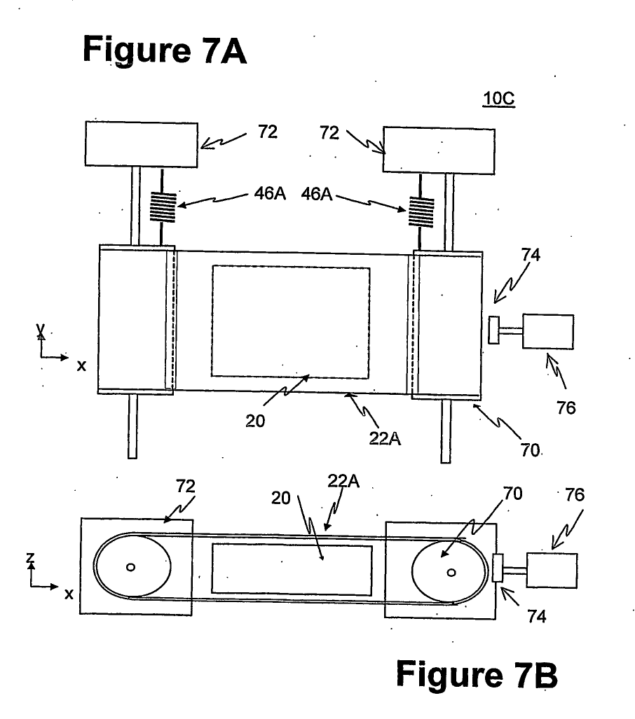

FIG. 7A shows a top view of a transparent overlay haptic device 10C in accordance with a third embodiment of the present invention. FIG. 7B shows a schematic side view of the transparent overlay haptic device 10C shown in FIG. 7A. The transparent overlay haptic device 10C keeps the two and a half degrees of freedom, but still reduces the size of the overall device in one axis (by using the concept of a roll of overlay instead of a sheet).

The transparent overlay haptic device 10C combines some of the advantages of the transparent overlay haptic device 10A in FIG. 3 (i.e. 2.5 degrees of freedom) and some of the advantages of the transparent overlay haptic device 10B in FIGS. 6A and 6B (i.e. reduction in size). In the device 10C, a homing mechanism 46A (such as a spring) is provided for one direction (i.e. y-axis), but not in direction of the roller motion (i.e. x-axis). This embodiment also allows for the easy incorporation of motors into the design (i.e. convert the device to an active device).

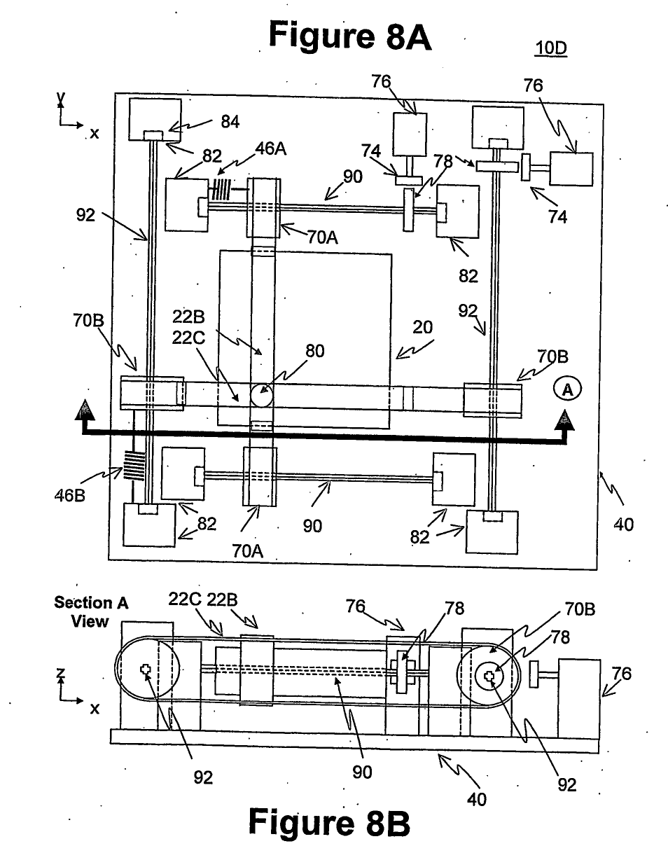

FIG. 8A shows a schematic top view of a transparent overlay haptic device 10D in accordance with a fourth embodiment of the present invention. FIG. 8B shows a schematic cross side view of the transparent overlay haptic device 10D shown in FIG. 8A. The transparent overlay haptic device 10D keeps the two and one half degrees of freedom and significantly reduces the size of the device, at the cost of forcing the user place their finger at a predefined location.

In FIGS. 8A-8B, the full overlay has been replaced with strips of overlay film that pass over one set of rollers 70A for the x-axis and another set of rollers 70B for the y-axis. Two strips 22B and 22 C are shown in FIGS. 8A-8B. The two strips 22B, 22C are attached together where the two strips intersect above the display 20, and a divot 80 is placed at the same location. The user places their finger on the divot 80 when they make contact with the device 10D. Optional homing mechanisms 46A, 46B, such as springs, ensure that the divot 80 is returned to the home position (e.g. the lower left corner of the display) once the user removes their finger from the device. Each roller 70A, 70B can slide along a spline axle (perpendicular to the axis of rotation) and the axle is attached to the spline mounts 82 through spline bearings 84 that allow the axle to rotate. In FIGS. 8A-8B, x-axis splines 90 and y-axis splines 92 are shown. As the axle rotates, the roller also rotates, which causes the overlay strip to pass over the roller, thus moving the divot 80 in one axis. A disc 78 is mounted on the axle at a fixed distance from the mount 82 and is part of the braking system. The solenoid brake actuator 76 with the brake pad 74 is mounted opposite the disc 78 so that when the solenoid is engaged, the disc rotation is restricted, which in turn, will restrict the divot 80 from moving in one axis. The transparent overlay haptic device 10D also allows for the easy incorporation or motors on the spline axle assembly, thus easily making the device 10D an active haptic device. Since rollers are incorporated in both axes, the size of the device does not need to be much larger than the actual display.

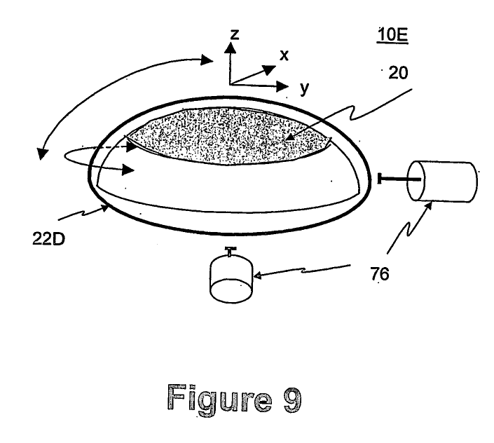

FIG. 9 shows a transparent overlay haptic device 10E in accordance with a fifth embodiment of the present invention. The transparent overlay haptic device 10E keeps the two and one half degrees of freedom and significantly reduces the size of the device, without forcing the user to place their finger at a predefined location.

The transparent overlay haptic device 10E includes an overlay 22D which has a closed surface (e.g. a sphere). The user can continuously move the overlay 22D in either the x or y axis without having an edge of the overlay pass over the display area.

The actuators in the transparent overlay haptic device 10E are the solenoid brakes 76. An X-Y position sensor is provided if the display 20 is not touch sensitive. In this embodiment, there is no need for a homing mechanism for the overlay 22D. The footprint (i.e. size in the x and y direction) of this embodiment is smaller than the preferred embodiment, but this embodiment is much deeper (i.e. size in the z direction).

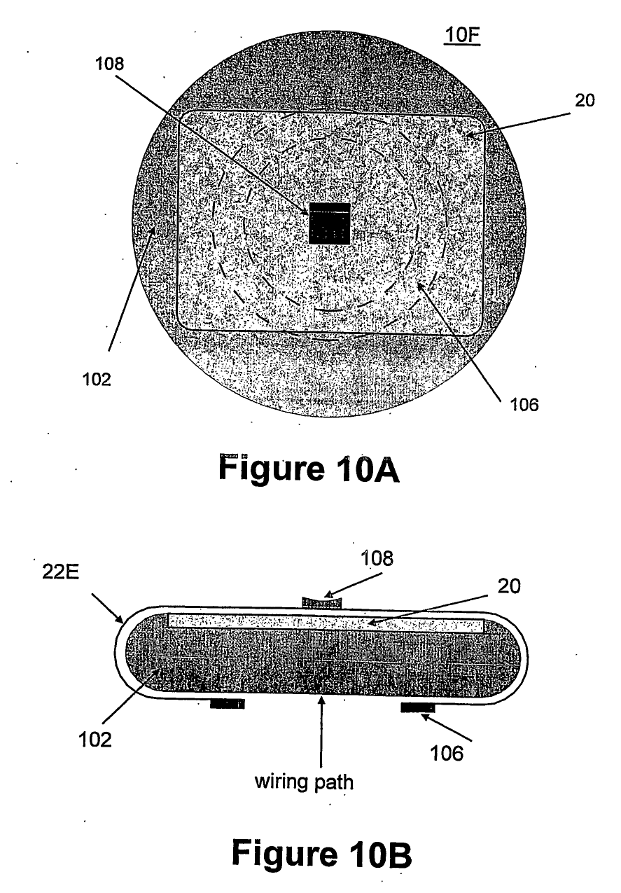

FIG. 10A shows a top view of a transparent overlay haptic device 10F in accordance with a sixth embodiment of the present invention. FIG. 10B shows a schematic side view of the transparent overlay haptic device 10F. The device 10F retains two and one half degrees of freedom and also reduces the size of the device.

The device 10F has a clear plastic overlay 22E, which wraps around a frame 102 which houses the LCD display 20. The frame 102 is coated by Teflon (trade-mark). Attached to the clear plastic overlay 22E on the underside of the frame 102 is a magnet, electromagnet or a series of magnets/electromagnets. In FIGS. 10A and 10B, a magnetic ring 106 is attached to the underside of the frame 102. As the user moves the clear plastic overlay 22E via the finger rest 108, the attached magnets/electromagnets move relative to the Teflon frame 102. The finger rest 108 is optional if there is sufficient friction between the user's finger and the transparent overlay haptic device 10F. By actuating the electromagnet or by actuating external electromagnets, haptic effects are applied to the user's finger. For example, if the frame 102 is metallic, a braking force may be employed by simply actuating an attached electromagnet. The transparent overlay haptic device 10F can be augmented with a homing device to return the finger rest to a predefined position. The transparent overlay haptic device 10F has the potential to be compact and versatile.

The position sensor 26 of FIG. 1 is now described in detail. An absolute position sensor and/or a relative position sensor may be employed as the position sensor 26.

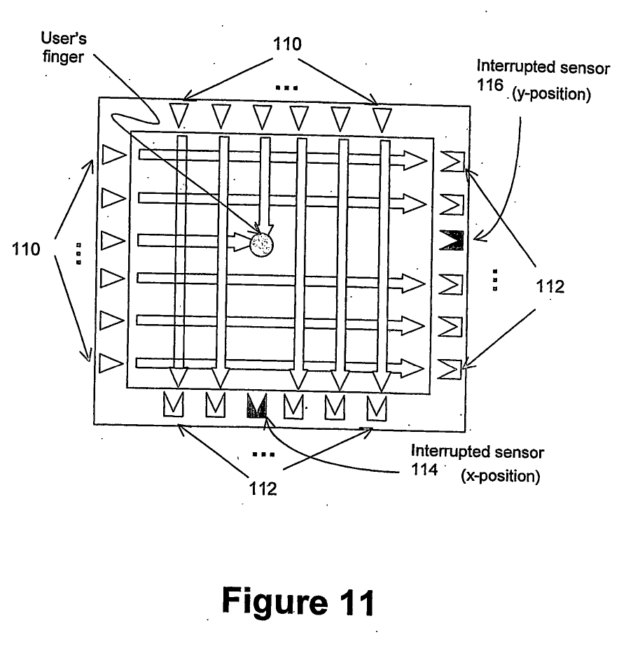

The absolute position sensor is described in detail. The absolute position sensor provides the absolute position of the user's finger. The touch sensitive LCD falls into this category. FIG. 11 shows an alternate absolute position sensing mechanism. The absolute position sensor of FIG. 11 includes an array of photo-diodes 110 and photo sensors (or detectors) 112 around the outside of the display 20. In the absolute position sensor of FIG. 11, the photo-sensor output is monitored. When the user's finger interrupts the beam of light from the photo-diodes 110, the interruption is monitored by the sensors 114 and 116 within the sensors 112. Thus, the x and y positions of the user's finger are obtained. Some encoders and potentiometers also measure absolute position and may be used.

The relative position sensor is described in detail. The relative position sensor measures the change in position. Examples of sensors that fall into this category are optical sensors (e.g. those used in optical mice), encoders on rollers, and potentiometers on rollers. While these sensors may be less expensive and simpler in design, they require a calibration to be performed to determine a home position. All measurements are then taken relative to the determined home position.

As described above, a LCD may be provided to the transparent overlay haptic device 10. However, any other display technologies can also be used. For example, a Cathode Ray Tube (CRT) display, a plasma display, a projection display, or a Light Emitting Diode (LED) display are applicable.

As described above, the transparent overlay haptic device 10 can be made active with the addition of motors, or other active devices (e.g. solenoids, shape memory alloys, pneumatics, hydraulics). With the addition of the active components, the homing mechanism can also be removed since the active actuator can drive the overlay to the home position after the user removes their finger from the device.

A transparent overlay haptic device, which is similar to the device 10D, can be used to eliminate the requirement that the user always starts from a home position. To accomplish this, the device is made active with the addition of motors to drive the spline axles. The position sensor 26 is accomplished with an array of photo-diodes and photo-sensors, such as the position sensor of FIG. 11. The position sensor is placed far enough from the display 20 so that as the user's finger approaches the display 20, the position is obtained and the controller 28 drives the motor such that the divot 80 is placed just below the user's finger just before contact is made with the display 20. Once the user's finger is on the divot 80, haptic effects can be felt by actively driving the motors.

The braking schemes of FIGS. 3A-3B uses push rod braking schemes. However, alternate braking schemes can be employed, such as disc braking, locking pin brakes, eddy current brakes, or other mechanical braking mechanisms.

In each of the above embodiments, the user is allowed to initially place their finger at any starting point within the display area. An alternate approach may be applicable, which makes the user always place their finger at a pre-defined initial position. This would remove the requirement for calibration of the relative position sensor, since the pre-defined initial position would be the home position. The initial pre-defined position may be marked with a dimple or rougher texture on the overlay 22.

According to the embodiment of the present inventions, the main advantages include, but are not limited to the following:

a) Haptic effects are provided to users without obstructing the view of a display.

b) The passive embodiment of the transparent overlay haptic device is less expensive than other conventional haptic devices since motors are not required.

c) The embodiments described can easily be extended to use motors to implement more complex haptic effects if desired.

d) The user can primarily rely on the sense of touch to navigate through the option selection. This further compliments the phenomena known as muscle memory (the phenomena that a user can remember where objects are located in space after repetitive motion). This reduces the amount of attention required to perform other tasks, and provides less distraction to the main task.

e) The reconfigurability of the transparent overlay haptic device allows for intuitive design of the user interface. For example, for adjustment of the mirrors in a vehicle, it may be more intuitive to use the knob as a slider instead or using the rotational axis of the knob as an input.

f) The reconfigurability of the transparent overlay haptic device allows for the customization of the user interface.

g) If a touch sensitive display is used, then failure of the haptic portion of the device (e.g. the overlay breaks, the roller gets stuck) does not prevent the operation of the device, since the user can still select options by pressing on the display 20.

The transparent overlay haptic device 10 and its system 5 can be used in the automotive industry, aerospace industry, game industry or any other application where several control functions are integrated into a single input device and, for specific reasons (e.g. safety), the user cannot be distracted from other tasks.

While particular embodiments of the present invention have been shown and described, changes and modifications may be made to such embodiments without departing from the true scope of the invention.

1. A system for providing haptic effects to a user, comprising:
an image device for producing an image of an object on a display
a transparent overlay movably placed on the display for providing the image on the display to the user and moving with a finger of the user engaged with the transparent overlay;
a position sensor for sensing a position of the finger of the user on the transparent overlay relative to the display; and
a module for generating a haptic effect on the transparent overlay in response to the sensed position,
wherein the user receives the haptic effect through the transparent overlay.

2. A system according to claim 1, wherein the display is a touch sensitive display comprising the position sensor, for sensing the position of the user's finger.

3. A system according to claim 2, wherein the transparent overlay is a clear sheet and is adapted to allow forces applied by the user to transmitted through to the touch sensitive display.

4. A system according to claim 1, wherein the module comprises a controller for processing information provided from the position sensor to simulate the haptic effect.

5. A system according to claim 4, wherein the module further comprises an actuator for interfacing with the transparent overlay, and wherein the controller controls the actuator to generate the haptic effect on the transparent overlay.

6. A system according to claim 5, further comprising a communication interface for communication between the controller and an external system.

7. A system according to claim 1, wherein the module comprises an overlay homing assembly to move the transparent overlay to a home position.

8. A system according to claim 7, wherein the overlay homing assembly comprises at least one spring attached to the transparent overlay and a base of the system.

9. A system according to claim 1, wherein the module comprises an actuator assembly for generating a force to provide the haptic effect on the transparent overlay.

10. A system according to claim 9, wherein the actuator assembly comprises a solenoid, a brake pad and a brake pad bracket.

11. A system according to claim 1, wherein the module comprises a controller for generating a signal to simulate the haptic effect based on the sensed position and an actuator engaged with the transparent overlay for imparting force on the transparent overlay in response to the signal.

12. A system according to claim 11, wherein the haptic effect comprises a thin wall effect for briefly holding the transparent overlay in a fixed position when the user collides with the image of the object, and wherein the controller generates the signal to simulates the thin wall effect.

13. A system according to claim 11, wherein the haptic effect comprises a thick wall effect for preventing the user from entering an area of the image, and wherein the controller generates the signal to simulates the thick wall effect.

14. A system according to claim 11, wherein the haptic effect comprises an effect of one or more walls, one or more edges or combinations thereof for providing a sense of wall and/or edge, and wherein the controller generates the signal to simulate the effect of one or more walls, one or more edges or combinations thereof.

15. A system according to claim 11, wherein the controller generates the signal to simulates the haptic effect associated with a mechanical control device.

16. A system according to claim 11, wherein the controller has a functionality of generating audio feedback.

17. A system according to claim 11, wherein the controller has a functionality of controlling the image of the object in accordance with the haptic effect.

18. A system according to claim 1, wherein the module generates the haptic effects in a passive manner.

19. A system according to claim 1, wherein the module generates the haptic effects in an active manner.

20. A system according to claim 1, wherein the module comprises a braking system for generating the haptic effects in a passive manner.

21. A system according to claim 1, wherein the transparent overlay is a circular sheet.

22. A system according to claim 21, wherein the module comprises a roller for rotating the transparent overlay along one axis over the display.

23. A system according to claim 22, wherein the module further comprises a braking system for applying a brake to the transparent overlay along one axis.

24. A system according to claim 22, wherein the module further comprises a homing mechanism to sustain the transparent overlay along an axis.

25. A system according to claim 1, wherein the transparent overlay comprises an overlay strip for the x-axis and an overlay strip for the y-axis.

26. A system according to claim 25, wherein a divot is placed on an area where the strip for the x-axis intersects the strip for the y-axis.

27. A system according to claim 26, wherein the module comprises a homing mechanism to provide a home position for the divot.

28. A system according to claim 26, wherein the module comprises a roller for the x-axis, a roller for the y-axis, a spline axle for the x-axis and a spline axle for the y-axis, the roller for the x-axis sliding along and being driven by the spline axle for the x-axis and the roller for the y-axis sliding along and being driven by the spline axle for the y-axis.

29. A system according to claim 28, wherein the module further comprises spline mounts and spline bearings, the axle being attached to the spline mounts through the spline bearings such that the axle rotates.

30. A system according to claim 28, wherein the roller rotates in response to a rotation of the axle, the rotation of the roller allowing the strip to pass over the roller and the divot to move in one axis.

31. A system according to claim 25, wherein the module further comprises a braking system for applying a brake to the strips.

32. A system according to claim 31, wherein the braking system comprises a disc brake applied to a drive mechanism of the strip for the x-axis and a disc brake applied to a drive mechanism of the strip for the y-axis.

33. A system according to claim 32, wherein the braking system further comprises solenoid brakes, each of which is mounted such that the rotation of the disc is restricted when the solenoid is engaged.

34. (canceled)

35. A system according to claim 1 wherein the position sensor comprises an absolute position sensor and/or a relative position sensor.

36. A system according to claim 35, wherein the absolute position sensor comprises an array of photodiodes and photo detectors around the outside of the display.

37. A system according to claim 35, wherein the relative position sensor comprises an optical sensor.

38. A system according to claim 35, wherein the relative position sensor comprises encoders.

39. A system according to claim 35, wherein the relative position sensor comprises potentiometers.

40. A system according to claim 1, wherein the display is selected from the group consisting of liquid crystal displays, cathode ray tube displays, plasma displays, projection displays, and/or light emitting diode displays.

41. A system according to claim 1, wherein the module comprises a braking system selected from the group consisting of push rod braking mechanisms, disc braking mechanisms, locking pin braking mechanisms, eddy current braking mechanisms, and other mechanical braking mechanisms.

42. A system according to claim 1, wherein the display is wrapped by the transparent overlay.

43. A system according to claim 42, wherein the module comprises a frame for housing the display, a moving element which moves relative to the frame and an actuator for actuating the element, the frame and the display being wrapped by the transparent overlay.

44. A system according to claim 43, wherein the moving element is selected from the group consisting of one or more magnets, one or more electromagnets, and a combination of one or more magnets and one or more electromagnets.

45. (canceled)

46. A method of applying a force in the x and y axis to a finger of a user, via a transparent overlay movably placed on a display, the display being viewable through the overlay to the user and movable with the finger of the user, the method comprising the steps of:
sensing a position of the finger of the user on the transparent overlay relative to an object displayed on the display;
generating a haptic effect on the transparent overlay in response to the sensed position; and
providing force corresponding to the haptic effect, imparted to the user through the transparent overlay.

47. A method according to claim 46, wherein the step of providing the force comprises the step of passively providing the force to the user.

48. A method according to claim 46, wherein the step of providing the force comprises the step of actively providing the force to the user.
